(19) United States
(12) Patent Application Publication
(10) Pub. No.: US 2010/0164240 A1
(43) Pub. Date: Jul. 1, 2010

(54) PET MESS TOOL

(76) Inventor: James L. Moore, Taylor, MI (US)

Correspondence Address: FRASER CLEMENS MARTIN & MILLER LLC, 28366 KENSINGTON LANE, PERRYSBURG, OH, 43551, US

(21) Appl. No.: 12/646,159

(22) Filed: Dec. 23, 2009

Related U.S. Application Data
(60) Provisional application No. 61/141,044, filed on Dec. 29, 2008.

(51) Int. Cl. A01K 29/00

(52) U.S. Cl. 294/1.3

(57) ABSTRACT

A tool for cleaning a pet “mess” from a surface includes a body having a rear wall coupled to a bottom wall, a handle extending generally rearwardly from the rear wall, and an opening formed in the rear wall exposing a rear edge of the bottom wall. When the bottom wall is placed on the surface with the rear edge adjacent the pet “mess”, the handle is grasped by a human hand for pulling the body toward the pet “mess” and between the “mess” and the surface to scoop the “mess” into the body.

### CROSS-REFERENCE TO RELATED APPLICATION

This application claims the benefit of U.S. Provisional Patent Application No. 61/141,044 filed on Dec. 29, 2008, hereby incorporated herein by reference in its entirety.

### FIELD OF THE INVENTION

The present invention relates to a tool for removing pet “messes” from surfaces such as floors, rugs, and furniture.

### BACKGROUND OF THE INVENTION

Domestic pets, such as cats and dogs, are prone to depositing “messes” such as feces and vomit on surfaces in the home. These “messes” can be difficult to clean up. When a scoop type tool is used, the “mess” tends to be pushed ahead rather than moving rearwardly into the tool. Therefore, it would be desirable to develop a tool for removing pet “messes” from surfaces that would enable the “mess” to be picked up in place.

### SUMMARY OF THE INVENTION

Concordant and consistent with the present invention, a tool for removing pet “messes” from surfaces that would enable the “mess” to be picked up in place, has surprisingly been discovered.

In one embodiment, a tool for cleaning a pet “mess” from a surface comprises: a body having a rear wall coupled to a bottom wall; a handle extending generally rearwardly from said rear wall; and an opening formed in said rear wall exposing a rear edge of said bottom wall, whereby when said bottom wall is placed on the surface with said rear edge adjacent the pet “mess”, said handle is grasped by a human hand for pulling said body toward the pet “mess” and between the “mess” and the surface to scoop the “mess” into the body.

In another embodiment, a tool for cleaning a pet “mess” from a surface comprises: a body having a rear wall attached to a bottom wall; a handle extending laterally outwardly from said rear wall; and an opening formed in said rear wall exposing a rear edge of said bottom wall, whereby when said bottom wall is placed on the surface with said rear edge adjacent the pet “mess”, said handle is grasped by a human hand for pulling said body toward the pet “mess” and between the “mess” and the surface to scoop the “mess” into the body.

In yet another embodiment, a tool for cleaning a pet “mess” from a surface comprises: a body having a rear wall attached to a bottom wall, wherein said bottom wall extends in a generally horizontal plane forward from said rear wall along a portion of said body and then angles generally upwardly to a front end of said body; a handle coupled to said rear wall; and an opening formed in said rear wall exposing a rear edge of said bottom wall, whereby when said bottom wall is placed on the surface with said rear edge adjacent the pet “mess”, said handle is grasped by a human hand for pulling said body toward the pet “mess” and between the “mess” and the surface to scoop the “mess” into the body.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a front perspective view of a pet mess tool according to an embodiment of the present invention;

FIG. 2 is a rear perspective view of the pet mess tool of FIG. 1;

FIG. 3 is a fragmentary side elevation view in partial cross section of the pet mess tool of FIG. 1;

FIG. 4 is a front perspective view of a pet mess tool according to another embodiment of the present invention;

FIG. 5 is a rear perspective view of the pet mess tool of FIG. 4;

FIG. 6 is a fragmentary side elevation view in partial cross section of the pet mess tool of FIG. 4;

FIG. 7 is a front perspective view of a pet mess tool according to another embodiment of the present invention;

FIG. 8 is a rear perspective view of the pet mess tool of FIG. 7;

FIG. 9A is a fragmentary side elevation view in partial cross section of the pet mess tool of FIG. 7; and

FIG. 9B is a fragmentary side elevation view in partial cross section of the pet mess tool of FIG. 7.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

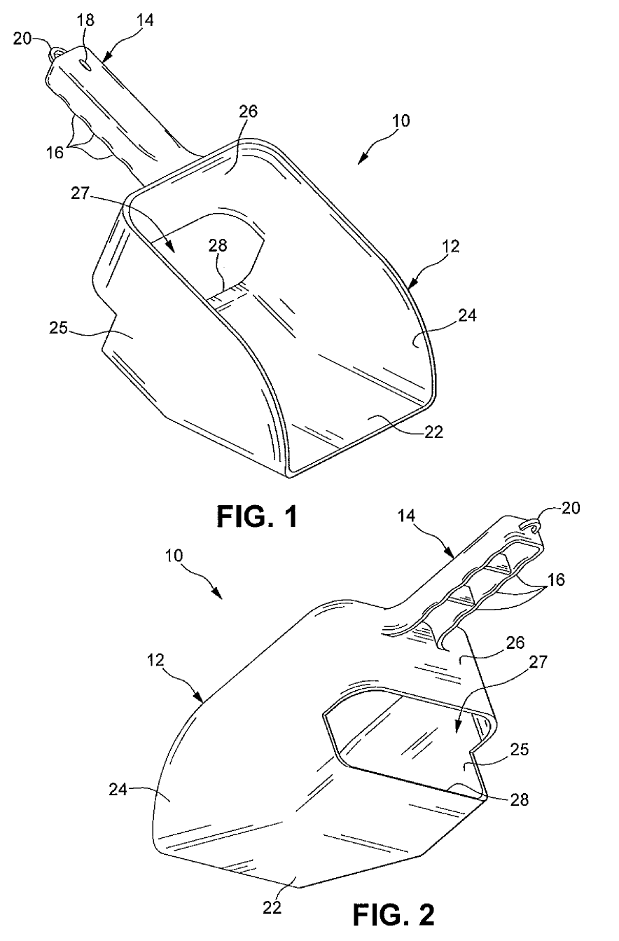

FIGS. 1-3 illustrate a pet mess tool 10 according to an embodiment of the present invention. As shown, the tool 10 has a cup shaped body 12 from which extends a handle 14. As a non-limiting example, the handle 14 includes a plurality of ridges 16 formed therein to provide an ergonomic gripping surface for a human hand. As a further non-limiting example, a means for suspending the tool 10 during storage thereof is formed in the handle 14 such as an aperture 18 or a hanging tab 20.

The body 12 has a bottom wall 22 coupled to a pair of spaced apart side walls 24, 25. A rear wall 26 extends between the side walls 24, 25 and connects the bottom wall 22 to close the rear of the body 12. The bottom wall 22 extends in a generally horizontal plane forward from the rear wall 26 along a portion of the body 12 and then angles upwardly to an open front end of the body 12.

An opening 27 is formed in a lower portion of the rear wall 26 down to the plane of the bottom wall 22. The opening 27 exposes a rear edge 28 of the bottom wall 22.

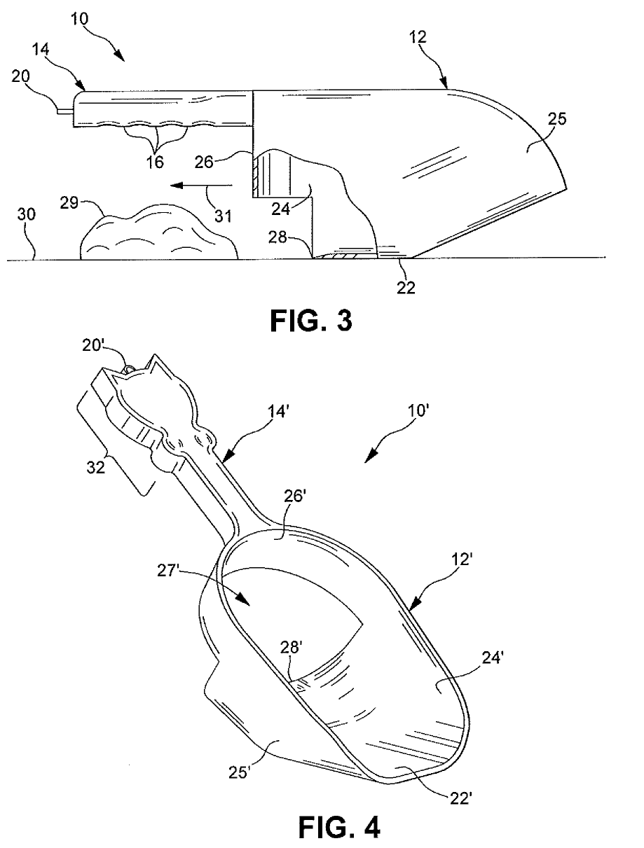

As more clearly shown in FIG. 3, a pet “mess” 29 is resting on a surface 30 such as a floor, a rug, a furniture seat cushion, etc. The tool 10 is positioned with the bottom wall 22 resting on the surface 30 and the rear edge 28 adjacent the “mess” 29. Using the handle 12, the tool 10 is rapidly pulled in the direction of an arrow 31 to engage the “mess” 29. Since a body at rest tends to stay at rest, the “mess” 29 tends to stay in place as the edge 28 is pulled between the “mess” 29 and the surface 30 in the direction of the arrow 31 to scoop the “mess” 29 into the body 12. As shown, a portion of the bottom wall 22 is tapered toward the rear edge 28 to assist in separating the “mess” 29 from the surface 30. However, it is understood that the rear edge 28 may have any shape, as desired.

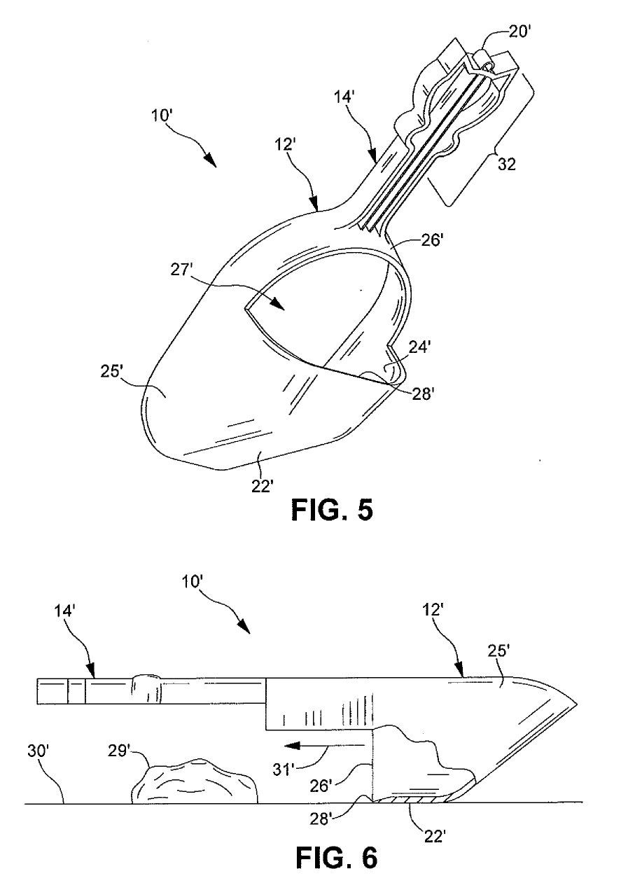

FIGS. 4-6 illustrate a pet mess tool 10′ according to another embodiment of the present invention similar to the pet mess tool 10 of FIGS. 1-3, except as described below. Structure repeated from the description of FIGS. 1 and 2 includes the same reference numeral and a prime (′) symbol.

As shown, the tool 10′ is smaller in size relative to the tool 10. The tool 10′ has a cup shaped body 12′ from which extends a handle 14′. As a non-limiting example, the handle 14′ includes an ornamental feature 32 formed such as a silhouette of a pet. It is understood that the ornamental feature 32 can be designed to provide an ergonomic gripping surface for a human hand. As a further non-limiting example, a means for suspending the tool 10′ during storage thereof is formed in the handle 14′ such as a hanging tab 20′.

As more clearly shown in FIG. 6, a pet “mess” 29′ is resting on a surface 30′ such as a floor, a rug, a furniture seat cushion, etc. The tool 10′ is positioned with the bottom wall 22′ resting on the surface 30′ and the rear edge 28′ adjacent the “mess” 29′. Using the handle 12′, the tool 10′ is rapidly pulled in the direction of an arrow 31′ to engage the “mess” 29′. Since a body at rest tends to stay at rest, the “mess” 29′ tends to stay in place as the edge 28′ is pulled between the “mess” 29′ and the surface 30′ in the direction of the arrow 31′ to scoop the “mess” 29′ into the body 12′. As shown, the rear edge 28′ can be tapered to assist in separating the “mess” 29′ from the surface 30′. However, it is understood that the rear edge 28′ may have any shape, as desired.

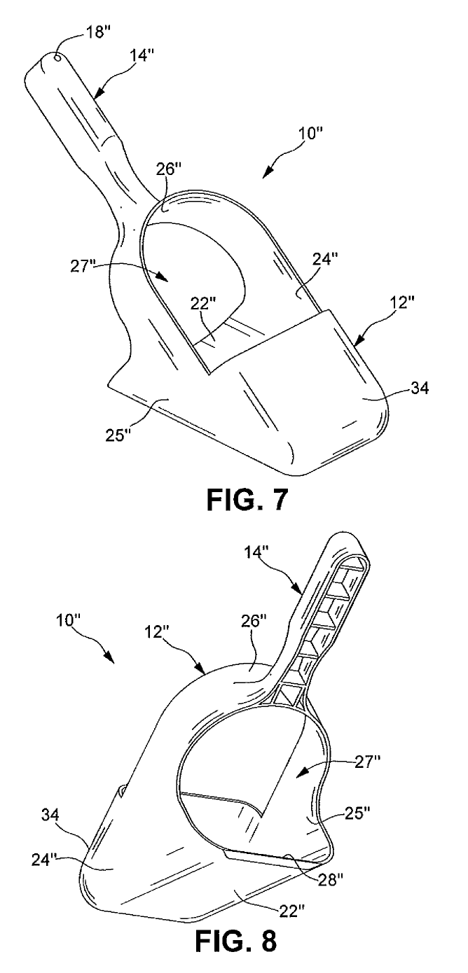

FIGS. 7-9 illustrate a pet mess tool 10″ according to another embodiment of the present invention similar to the pet mess tool 10 of FIGS. 1-3, except as described below. Structure repeated from the description of FIGS. 1-3 includes the same reference numeral and a double-prime (″) symbol.

As shown, the tool 10″ has a cup shaped body 12″ from which extends a handle 14″. As a non-limiting example, an aperture 18″ is formed in the handle 14″ for suspending the tool 10″ during storage thereof.

The body 12″ has a bottom wall 22″ coupled to a pair of spaced apart side walls 24″, 25″. A rear wall 26″ extends between the side walls 24″, 25″ and connects the bottom wall 22″ to close the rear of the body 12″. The bottom wall 22″ extends in a generally horizontal plane forward from the rear wall 26″. A front wall 34 extends between the side walls 24″, 25″ and connects the bottom wall 22″ to close at least a portion of the front of the body 12″.

An opening 27″ is formed in a lower portion of the rear wall 26″ down to the plane of the bottom wall 22″. A rear edge 28″ of the bottom wall 22″ is disposed adjacent the opening 27″.

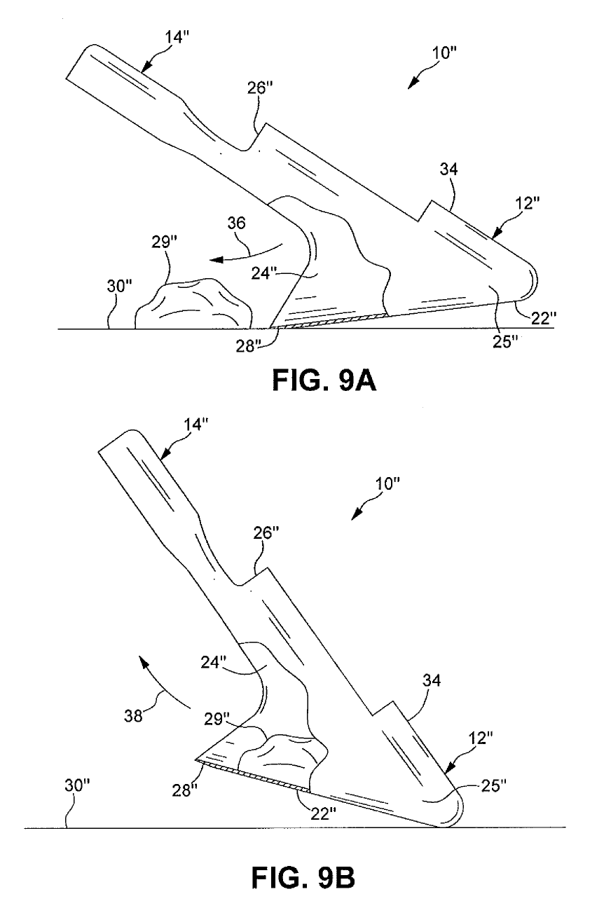

As more clearly shown in FIGS. 9A-9B, a pet “mess” 29″ is resting on a surface 30″ such as a floor, a rug, a furniture seat cushion, etc. The tool 10″ is positioned with a portion of the bottom wall 22″ resting on the surface 30″ and adjacent the “mess” 29″. Using the handle 14″, the tool 10″ is rapidly pulled in the direction of an arrow 36 to engage the “mess” 29″. Since a body at rest tends to stay at rest, the “mess” 29″ tends to stay in place as the edge 28″ is pulled between the “mess” 29″ and the surface 30″ in the direction of the arrow 36 to scoop the “mess” 29″ into the body 12″. Once the “mess” 29″ is in the body 12″ a continued scooping motion in the direction of arrow 38 causes the “mess” 29″ to move toward the front wall 34 and rest thereagainst for transfer and subsequent disposal. As shown, the rear edge 28″ can be tapered to assist in separating the “mess” 29″ from the surface 30″. However, it is understood that the rear edge 28″ may have any shape, as desired.

The tool 10, 10′, 10″ provides a means for the pet “mess” 29, 29′, 29″ to be picked up in place, easily transported, and disposed in an appropriate location, while minimizing a residue of the pet “mess” 29, 29′, 29″ on the surface 30, 30′, 30″.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A tool for cleaning a pet “mess” from a surface, the tool comprising:
a body having a rear wall coupled to a bottom wall;
a handle extending generally rearwardly from said rear wall; and
an opening formed in said rear wall exposing a rear edge of said bottom wall, whereby when said bottom wall is placed on the surface with said rear edge adjacent the pet “mess”, said handle is grasped by a human hand for pulling said body toward the pet “mess” and between the “mess” and the surface to scoop the “mess” into the body.

2. The tool according to claim 1, further comprising a pair of spaced side walls attached to said bottom wall and said rear wall to form a cup shaped interior space in said body.

3. The tool according to claim 1, further comprising a pair of spaced side walls attached to said bottom wall and a front wall to at least partially enclose a front end of said body.

4. The tool according to claim 1, wherein said bottom wall extends in a generally horizontal plane forward from said rear wall along a portion of said body and then angles generally upwardly to a front end of said body.

5. The tool according to claim 1, wherein a portion of said bottom wall is tapered toward said rear edge.

6. The tool according to claim 1, wherein said handle includes a plurality of ridges formed thereon to provide an ergonomic gripping surface for the human hand.

7. The tool according to claim 1, wherein said handle includes an ornamental feature formed thereon.

8. The tool according to claim 1, wherein said handle includes a means for suspending said body during storage thereof.

9. The tool according to claim 1, wherein said handle is generally parallel to at least a portion of said bottom wall.

10. A tool for cleaning a pet “mess” from a surface, the tool comprising:
a body having a rear wall attached to a bottom wall;
a handle extending laterally outwardly from said rear wall; and
an opening formed in said rear wall exposing a rear edge of said bottom wall, whereby when said bottom wall is placed on the surface with said rear edge adjacent the pet “mess”, said handle is grasped by a human hand for pulling said body toward the pet “mess” and between the “mess” and the surface to scoop the “mess” into the body.

11. The tool according to claim 10, further comprising a pair of spaced side walls attached to said bottom wall and said rear wall to form a cup shaped interior space in said body.

12. The tool according to claim 10, further comprising a pair of spaced side walls attached to said bottom wall and a front wall to at least partially enclose a front end of said body.

13. The tool according to claim 10, wherein said bottom wall extends in a generally horizontal plane forward from said rear wall along a portion of said body and then angles generally upwardly to a front end of said body.

14. The tool according to claim 10, wherein a portion of said bottom wall is tapered toward said rear edge.

15. The tool according to claim 10, wherein said handle includes a plurality of ridges formed thereon to provide an ergonomic gripping surface for the human hand.

16. The tool according to claim 10, wherein said handle includes an ornamental feature formed thereon.

17. The tool according to claim 10, wherein said handle includes a means for suspending said body during storage thereof.

18. The tool according to claim 10, wherein said handle is generally parallel to at least a portion of said bottom wall.

19. A tool for cleaning a pet “mess” from a surface, the tool comprising:
a body having a rear wall attached to a bottom wall, wherein said bottom wall extends in a generally horizontal plane forward from said rear wall along a portion of said body and then angles generally upwardly to a front end of said body;
a handle coupled to said rear wall; and
an opening formed in said rear wall exposing a rear edge of said bottom wall, whereby when said bottom wall is placed on the surface with said rear edge adjacent the pet “mess”, said handle is grasped by a human hand for pulling said body toward the pet “mess” and between the “mess” and the surface to scoop the “mess” into the body.

20. The tool according to claim 19, further comprising a pair of spaced side walls attached to said bottom wall and said rear wall to form a cup shaped interior space in said body.
